(19) United States
(12) Patent Application Publication
(10) Pub. No.: US 2012/0324976 A1
(43) Pub. Date: Dec. 27, 2012

(54) METHOD OF FORGING ALUMINUM/ALUMINUM ALLOYS

(75) Inventors: LI LONG, Shenzhen City (CN); CHAO-HSUN LIN, Tu-Cheng (TW)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/308,660

(22) Filed: Dec. 1, 2011

(30) Foreign Application Priority Data
Jun. 24, 2011 (CN) 201110172988.6

(51) Int. Cl. B21J 13/02; B23P 17/00; B21J 1/06

(52) U.S. Cl. 72/342.7

(57) ABSTRACT

A method of forging aluminum/aluminum alloys includes: providing an aluminum/aluminum alloy billet; providing a forging die, the forging die including an upper die and a lower die, the upper die and the lower die being all mounted with heating element and temperature controller; locating the aluminum/aluminum alloy billet in the forging die; heating the upper die and the lower die and making the temperature difference between the upper die and the lower die be about 100° C.-350° C.; forging the aluminum/aluminum alloy billet to get an aluminum/aluminum alloy forged piece, the temperature difference between the upper die and the lower die being kept at about 100° C.-350° C. during the forging process; and opening the upper die and the lower die to remove out the aluminum/aluminum alloy forged piece.

### BACKGROUND

1. Technical Field

The present disclosure relates to methods of forging aluminum/aluminum alloys, especially to a method of forging aluminum/aluminum alloys to form aluminum/aluminum alloy forged pieces having precise sizes.

2. Description of Related Art

Forging is the process by which metal is heated and is shaped by plastic deformation by suitably applying compressive force. Usually, the compressive force is in the form of a power hammer or a press. Isothermal forging is a precise forging process during which the forging temperature is not changed. With regard to dimensional accuracy and a minimal reworking, those products of isothermal forging conform to the high quality standards.

For aluminum/aluminum alloy forged pieces such as mobile phone assembly having protrusions with small sizes and thin sidewalls, the aluminum/aluminum alloy forged pieces should be urged out by urging the thin sidewall of the protrusion using a carrier rod after being isothermally forged. However, the aluminum/aluminum alloy forged pieces are usually at a high temperature and have weak strength once be forged, the thin sidewall of the protrusion being urged is prone to deformation.

Therefore, there is room for improvement within the art.

### BRIEF DESCRIPTION OF THE FIGURES

Many aspects of the disclosure can be better understood with reference to the following figures. The components in the figures are not necessarily drawn to scale, the emphasis instead being placed upon clearly illustrating the principles of the disclosure. Moreover, in the drawings like reference numerals designate corresponding parts throughout the several views.

FIG. 1 is a schematic view of an exemplary embodiment of a forging die.

FIG. 2 is a schematic view of an exemplary embodiment of an aluminum/aluminum alloy billet.

FIG. 3 is a schematic view of an exemplary embodiment of an aluminum/aluminum alloy forged piece.

FIG. 4 is a metallography image of the aluminum/aluminum alloy billet shown in FIG. 2.

FIG. 5 is a metallography image of the aluminum/aluminum alloy forged piece shown in FIG. 3.

### DETAILED DESCRIPTION

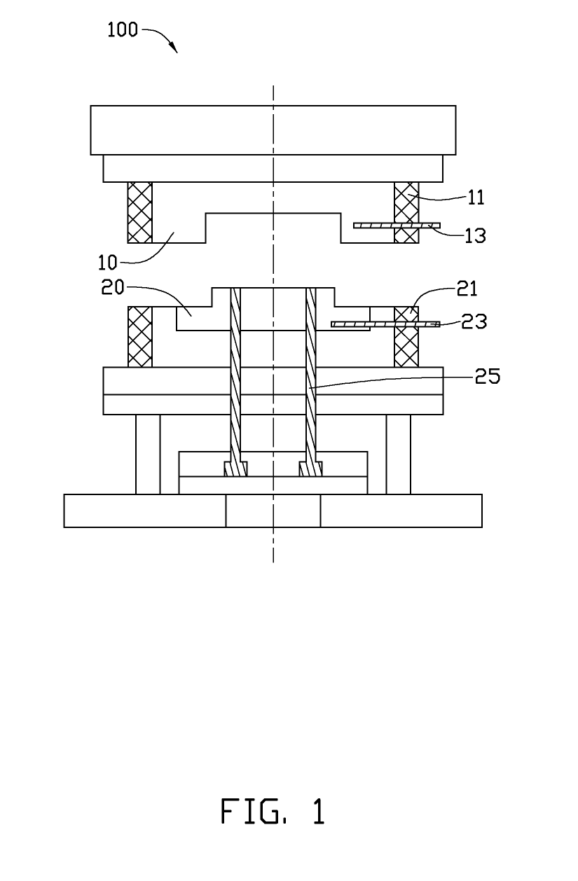

FIG. 1 shows a forging die 100 used to forge aluminum/aluminum alloy according to an exemplary embodiment. The forging die 100 includes an upper die 10 and a lower die 20. The upper die 10 is mounted with a first heating element 11 and a first temperature controller 13. The lower die 20 is mounted with a second heating element 21 and a second temperature controller 23. The first temperature controller 13 and the second temperature controller 23 are used to control the temperatures of the upper die 10 and the lower die 20 respectively. The lower die 20 also defines two carrier rods 25 which are used to urge out forged pieces. The carrier rods 25 may also be defined in the upper die 10. There may be more than two carrier rods 25.

The method of forging aluminum/aluminum alloy may include the following steps:

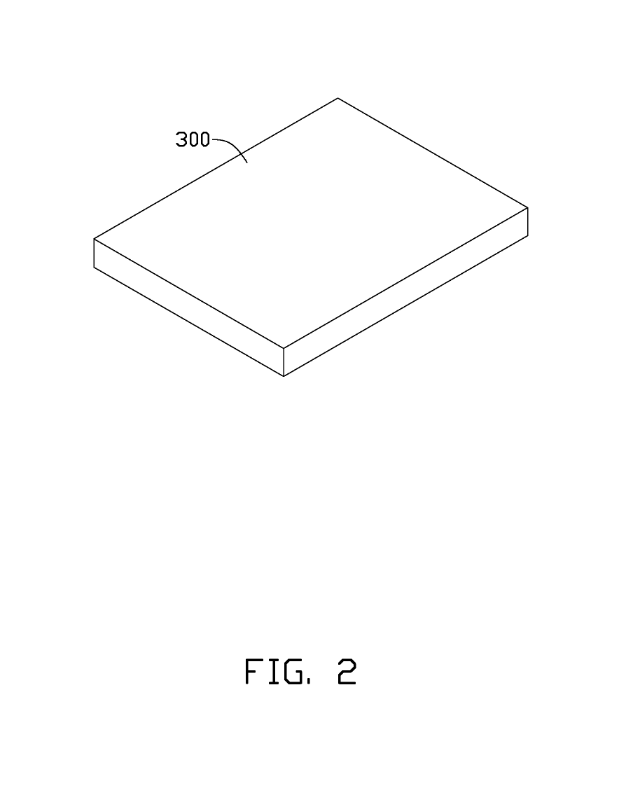

Referring to FIG. 2, aluminum/aluminum alloy is pre-processed to form an aluminum/aluminum alloy billet 300 with predefined shape. The pre-processing may include milling, stamping, or laser cutting.

The upper die 10 is heated by the first heating element 11. Simultaneously, the lower die 20 is heated by the second heating element 21. If forged piece is in the upper die 10 when unloading after forging process, the temperature of the upper die 10 may be lower than the lower die 20 by about 100° C.-350° C., and the lower die 20 is heated to about 300° C.-420° C. After the forging process, if the forged piece is in the lower die 20 when unloading, the temperature of the lower die 20 may be about 100° C.-350° C. lower than the upper die 10, and the upper die 10 is heated to about 300° C.-420° C.

The aluminum/aluminum alloy billet 300 is located in the lower die 20. The aluminum/aluminum alloy billet 300 may be pre-heated before being located in the lower die 20, or directly heated in the lower die 20.

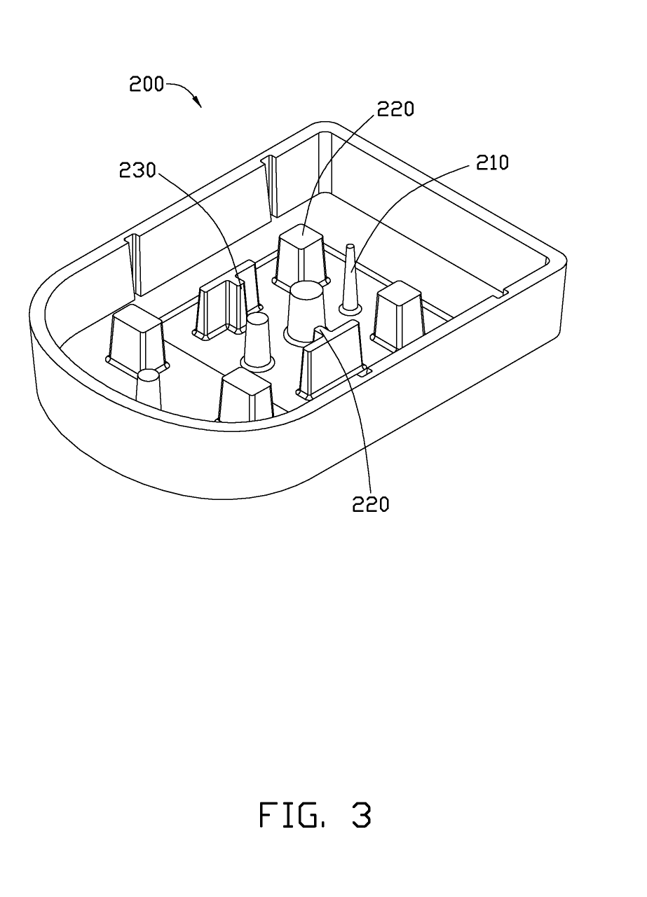

The upper die 10 and the lower die 20 are assembled, and an oil press machine (not shown) or a forging press machine (not shown) is used to attack the forging die 100 to forge the aluminum/aluminum alloy billet 300 to get an aluminum/aluminum alloy forged piece 200 (referring to FIG. 3). During the forging process, the temperature difference between the upper die 10 and the lower die 20 is about 100° C.-350° C. The temperature difference between the upper die 10 and the lower die 20 can be adjusted according to different forging billets, for example, the temperature difference can be increased and the forging lasting time can be prolonged when the forging billets have complex structures and thin sidewalls.

The upper die 10 and the lower die 20 are opened, then the carrier rods 25 start to urge and remove the aluminum/aluminum alloy forged piece 200.

The method of forging aluminum/aluminum alloys is also fit to forging magnesium/magnesium alloys.

### Example

The aluminum/aluminum alloy billet 300 is a 5052 aluminum alloy. The aluminum/aluminum alloy billet 300 has a size of 50 mm×43 mm×5 mm.

The upper die 10 is heated to about 360° C.-380° C., the lower die 20 is heated to about 160° C.-180° C., the temperature difference between the upper die 10 and the lower die 20 is about 100° C.-200° C. An oil press machine is used to attack the forging die 100 for about 1 min-2 min to form the aluminum/aluminum forged piece 200.

Referring to FIG. 3, the aluminum/aluminum forged piece 200 defines a plurality of cylindrical protrusions 210, square protrusions 220, and strengthening ribs 230. The least size of the cylindrical protrusions 210 is 1 mm² (bottom area)×10 mm (height). The strengthening rib 230 has a size of about 1.3 mm (width)×7 mm (height).

The cylindrical protrusions 210 and the square protrusions 220 are not deformed when the aluminum/aluminum alloy forged piece 200 is urged out, so the cylindrical protrusions 210 and the square protrusions 220 have precise sizes. This is because that there is temperature difference between the upper die 10 and the lower die 20 during the whole forging process, and the aluminum/aluminum alloy forged piece 200 is located in the lower temperature die (upper die 10 or lower die 20), which gives the aluminum/aluminum alloy forged piece 200 a greater strength comparing to a normal isothermal forging process.

The rigidity of the aluminum/aluminum alloy forged piece 200 has been tested. The test indicated that the rigidity of the aluminum/aluminum alloy forged piece 200 is no less than the aluminum/aluminum alloy billet 300.

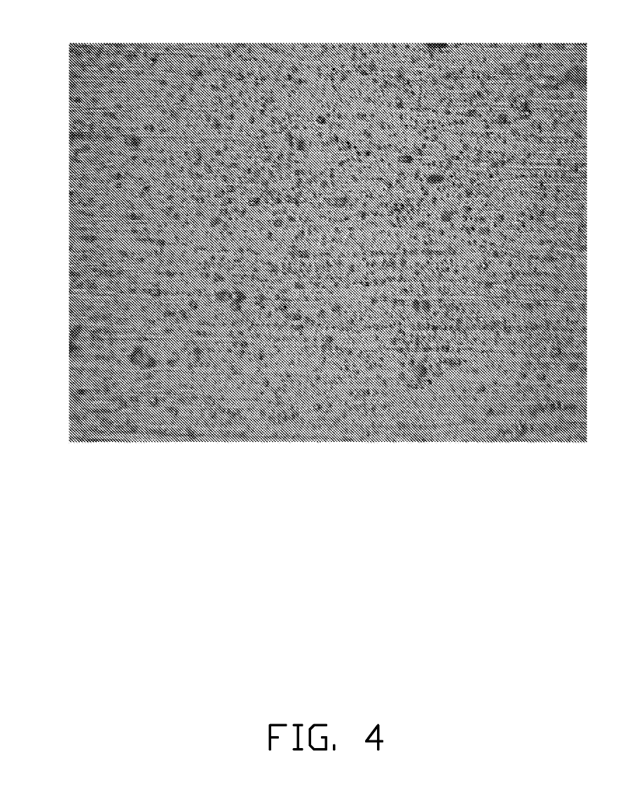

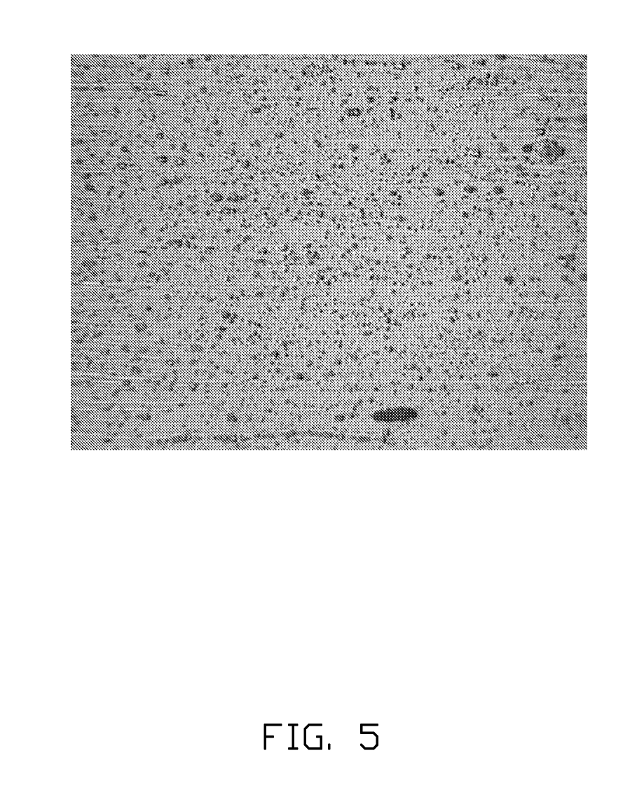

FIG. 4 and FIG. 5 show that there is no difference between the metallography structures of the aluminum/aluminum alloy billet 300 and the aluminum/aluminum alloy forged piece 200. This indicated that no stress concentration occurred on the aluminum/aluminum alloy forged piece 200 during the forging process.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A method of forging aluminum/aluminum alloys, comprising:
providing an aluminum/aluminum alloy billet;
providing a forging die, the forging die comprising an upper die and a lower die, the upper die and the lower die being all mounted with heating element and temperature controller;
locating the aluminum/aluminum alloy billet in the forging die;
heating the upper die and the lower die and making the temperature difference between the upper die and the lower die be about 100° C.-350° C., when the aluminum/aluminum alloy billet being located in the upper die, the upper die having a higher temperature of about 300° C.-420° C., when the aluminum/aluminum alloy billet being located in the lower die, the lower die having a higher temperature of about 300° C.-420° C.;
forging the aluminum/aluminum alloy billet to get an aluminum/aluminum alloy forged piece, the temperature difference between the upper die and the lower die being kept at about 100° C.-350° C. during the forging process; and
opening the upper die and the lower die to remove out the aluminum/aluminum alloy forged piece.

2. The method as claimed in claim 1, wherein the upper die is mounted with a first heating element and a first temperature controller, the lower die is mounted with a second heating element and a second temperature controller, the first and second heating elements are used to heat the upper die and the lower die respectively, the first and second temperature controllers are used to control the temperature of the upper die and the lower die respectively.

3. The method as claimed in claim 1, wherein the upper die or the lower die is defined with two or more carrier rods to urge the aluminum/aluminum alloy forged piece out of the die.

4. The method as claimed in claim 1, wherein the upper die and the lower die have a temperature difference of about 100° C.-200° C., the upper die has a temperature of about 360° C.-380° C., the lower die has a temperature of about 160° C.-180° C.

5. The method as claimed in claim 1, wherein the upper die and the lower die have a temperature difference of about 100° C.-200° C., the lower die has a temperature of about 360° C.-380° C., the upper die has a temperature of about 160° C.-180° C.

6. The method as claimed in claim 1, wherein the aluminum/aluminum alloy billet is formed by pre-processing aluminum/aluminum alloy material.

7. The method as claimed in claim 6, wherein the pre-processing process comprises milling, stamping, or laser cutting.

8. The method as claimed in claim 1, wherein the aluminum/aluminum alloy billet is pre-heated before being located in the forging die.

9. The method as claimed in claim 1, wherein the aluminum/aluminum alloy billet is pre-heated in the forging die before being forged.

10. The method as claimed in claim 1, wherein the aluminum/aluminum alloy billet is 5052 aluminum alloy.

11. The method as claimed in claim 1, wherein the aluminum/aluminum alloy forged piece defines protrusions thereon.

12. The method as claimed in claim 11, wherein the protrusion has a size of about 1 mm²×10 mm.

13. The method as claimed in claim 1, wherein the aluminum/aluminum alloy billet is substituted by magnesium/magnesium alloy billet.
